(19) United States
(12) Patent Application Publication
(10) Pub. No.: US 2004/0108423 A1
(43) Pub. Date: Jun. 10, 2004

(54) Telescopic support rod and a method of bringing about locking between two tubular elements thereof

(76) Inventors: Decimo Boaro, Cassola (IT); Luca Battaglia, Cassola (IT)

Correspondence Address: RATNERPRESTIA, P O BOX 980, VALLEY FORGE, PA, 19482-0980, US

(21) Appl. No.: 10/472,513

(22) PCT Filed: Mar. 21, 2002
(86) PCT No.: PCT/IT02/00181

(30) Foreign Application Priority Data
Mar. 23, 2001 (IT) MI2002A000620

(51) Int. Cl. F16M 13/00

(52) U.S. Cl. 248/161; 248/159

(57) ABSTRACT

A telescopic support rod. The rod has an inner tubular element and an outer tubular element which are interconnected slidably, wherein the tubular element is fixed by a lock. The lock includes at least one deformable element housed inside the inner tubular element and a control mechanism, inside the rod, for bringing about at least a transverse expansion of the deformable element.

### TECHNICAL FIELD

The present invention relates to a telescopic support rod and to a method of bringing about locking between two tubular elements thereof.

### TECHNOLOGICAL BACKGROUND

There are currently existing telescopic rods which can be positioned between a floor and a ceiling and which can hold supports for objects in general, such as hooks and/or lamps, etc.

A telescopic rod of this type comprises an inner tubular element and an outer tubular element which are slidable relative to one another and which can be locked by means of a locking device outside the rod.

However, these conventional rods have some disadvantages mainly due to the fact that the external locking device is unaesthetic and insecure since, as it is freely accessible, it may be released accidentally, causing the rod to fall down.

Moreover, because of their complexity and of the large number of components to be positioned and adjusted, conventional rods of the type described cannot easily be positioned between two vertical walls, but only between horizontal walls.

A telescopic support rod having the features outlined in the preamble of the main claim is disclosed in WO 98/08422. DE 876164 is also a relevant prior art.

### DESCRIPTION OF THE INVENTION

The technical task addressed by the present invention is therefore that of eliminating the technical problems discussed relating to the prior art.

Within the scope of this technical task, an object of the invention is to provide a telescopic rod in which the locking device is inside the rod.

Another object of the invention is to provide a telescopic rod which; as well as being able to be positioned between horizontal flat walls, can also be positioned without difficulty between substantially vertical walls.

One of the chief objects of the invention is to indicate a method of connecting two tubular elements of a telescopic rod.

The technical task, as well as thes and other objects, are achieved, according to the present invention, by the provision of a telescopic support rod made in accordance with the appended claims.

A further subject of the present invention is a method of bringing about locking between two tubular elements of a telescopic rod which is characterized in that a deformable element is expanded transversely and is simultaneously translated longitudinally, bringing about loose locking of the deformable element inside an inner tubular element of the telescopic rod and longitudinal translation of the inner tubular element itself and, subsequently, further expansion of the deformable element causing firm locking of the deformable element in the inner tubular element and locking of the inner and outer tubular elements of the rod.

Further characteristics of the present invention are also defined in the appended claims.

The rod according to the present invention advantageously has a completely free outer surface which can therefore support hooks without restrictions; moreover, the outer tube, to which the hooks are preferably connected, can rotate, permitting greater flexibility of use.

### BRIEF DESCRIPTION OF THE DRAWINGS

Further characteristics and advantages of the invention will become clearer from the description of a preferred but not exclusive embodiment of the telescopic support rod and of the method of connecting two tubular elements thereof according to the invention, the rod being illustrated by way of non-limiting example in the appended drawings, in which:

FIG. 1 is a longitudinal section through a rod according to the inventi n, in a configuration in which an inner tube is not locked,

FIG. 2 is a longitudinal section through the rod of FIG. 1, in a configuration in which the inner tube is locked, and support rod, generally indicated 1.

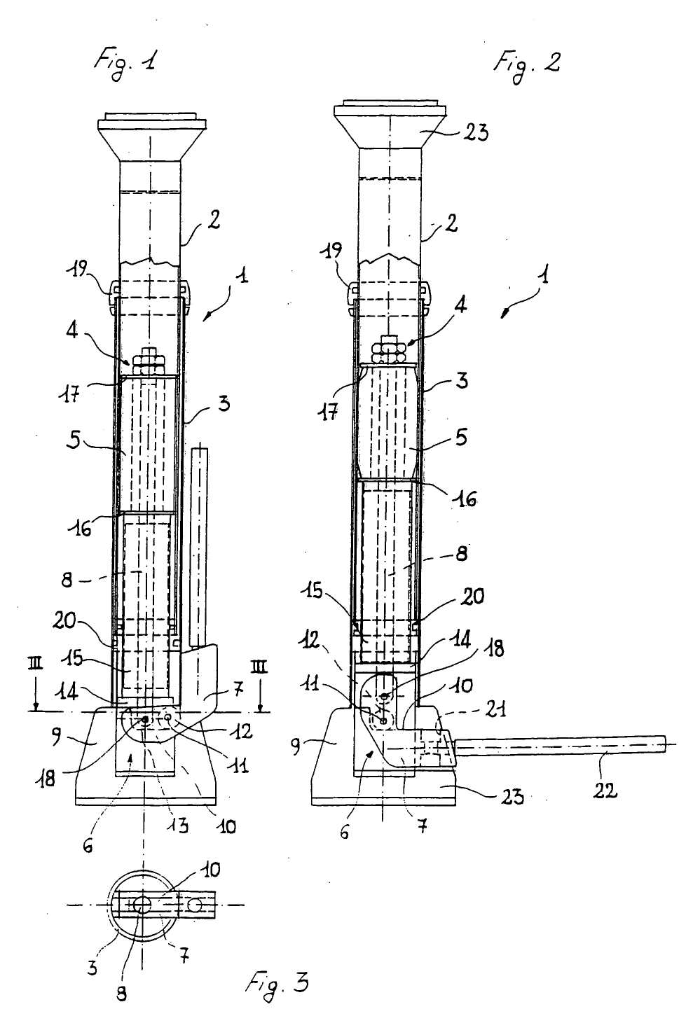

The rod 1 comprises an inner tubular element 2 and an outer tubular element 3 which are interconnected slidably, the tubular element 2 being locked by locking means 4.

The locking means 4 comprise a resiliently deformable element 5 housed inside the inner tubular element 2 and connected to a control mechanism 6 which is disposed inside the rod 1 and connected to the outer tubular element 3, and which can bring about at least a transverse expansion of the deformable element 5.

The control mechanism 6 comprises a lever 7 connected pivotably to a pin 8 associated with the deformable element 5.

The lever 7 is advantageously associated pivotably and slidingly with a support 9 which is fixed firmly to the outer tubular element 3 and has a cam 10.

A guide portion 11 of the lever 7 is associated with the cam 10 and, in a preferred embodiment, is provided with a wheel 12.

The cam 10 advantageously has a recessed seat 13 for housing the wheel 12 so as to ensure stability of the device in the locking configuration.

As shown in the embodiment illustrated, the pin 8 carries slidably a first annular plate 14 having one face in contact with the lever 7 and the other face connected to a spacer 15; at the other end of the spacer 15 a second annular plate 16 is slidable on the pin 8.

The deformable element 5 bears against the plate 16 and, in the embodiment shown, has an annular configuration; finally, a third annular plate 17 is disposed at the free end of the pin 8 and is locked by means of nuts on the threaded end of the pin 8.

In practice, therefore, the pin 8 carries the deformable element 5 and also carries, associated sildingly, the spacer 15, which is disposed between the lever 7 and the deformable element 5.

As is clear from the appended drawings, the pivotable connection of the pin 8 to the lever 7 is situated in a region 18 which is disposed at a first distance from one edge of the lever, which edge is associated with the spacer when the rod 1 is not locked, and at a second distance from another edge of the lever 7, which edge is associated with the spacer 15 when the device is locked.

The first distance is advantageously shorter than the second distance so that rototranslation of the lever 7 bring about translation of the spacer and compression of the deformable element.

Moreover, between the inner and outer tubular elements, there are centring spacers 19, 20 which enable the tubular elements 2, 3 to be kept correctly coaxial even when their diameters differ substantially (even with differences of the order of fractions of a millimetre).

The lever also has stop means which obstruct its movement when the rod is in the locked configuration.

The stop means comprise, for example, a seat 21 in which a handle 22 is inserted parallel to the rod.

The lever is thus unable to pivot since its pivoting would lead to pivoting of the handle 22.

The rod 1 has on one or, as in the embodiment shown, on both of its free ends, resilient elements 23, such as bellows, which promote connection to the walls.

The operation of the telescopic support rod according to the invention is clear from the foregoing description and from the drawings and, in particular, is substantially as follows.

The rod 1 is arranged between two horizontal or vertical walls, the ends being left spaced from the walls.

The handle 22 is inserted in the seat of the lever 7, bringing about pivoting thereof.

The lever 7 pivots and simultaneously translates along the cam 10 so that the pin 8, with the spacer 15 and the deformable element 5, translates inside the tubular elements 2, 3.

Owing to the shape of the lever 7 and the positioning of the connection region 18, the spacer 15 translates and compresses the deformable element 5, bringing about expansion thereof (since the element 5 is locked by the plate 17) and locking in the inner tubular element 2, together with the mechanism 6.

As the pin 8 translates, it pulls along the inner tubular element 2 (after it has been locked by the deformable element), causing lengthening of the rod 1 which thus becomes associated with the walls in an optimal manner.

Moreover, the inner tubular element 2 starts to slide relative to the outer tubular element 3 when the connection between the deformable element 5 and the inner tubular element 2 is still loose; this enables the deformable element 5 to slide in the inner tubular element 2 when the ends of the tubular elements 2 and 3 are restrained and, hence enables the dimensions of the rod to be maintained without stressing the walls excessively.

A further subject of the present invention is a method of connecting two tubular elements of a telescopic rod.

In this method, the deformable element 5 is expanded transversely and is simultaneously translated longitudinally, bringing about loose locking of the deformable element 5 inside the inner tubular element 2 of the telescopic rod 1 and longitudinal translation of the inner tubular element 2 itself.

Subsequently, further expansion of the deformable element 5 causes firm locking of the deformable element 5 in the inner tubular element 2 and locking of the inner and outer tubular elements 2, 3 of the rod 1.

In the method of the invention, when the deformable element 5 is locked loosely relative to the inner tubular element 2 of the rod 1 and the ends of the rod are restrained, preventing their translation, the deformable element 5 advantageously slides in the inner tubular element 2.

It has been found in practice that the telescopic support rod and the method of connecting two tubular elements thereof according to the invention are particularly advantageous because the locking means are entirely inside the rod which is therefore very secure and has an unrestricted surface for the anchorage of supports.

The telescopic support rod and the method of connecting two tubular elements thereof thus devised may undergo many modifications and variations all of which fall within the scope of the inventive concept; moreover, all of the details may be replaced by technically equivalent elements.

In practice, the materials used, as well as the dimensions, may be selected freely according to requirements and the state of the art.

1. A telescopic support rod (1) comprising an inner tubular element (2) and an outer tubular element (3) which are interconnected slidably, wherein the tubular element (2) is locked by locking means (4), characterized in that the locking means (4) comprise at least one deformable element (5) housed inside the inner tubular element (2) and a control mechanism (6), inside the rod (1), for bringing about at least a transverse expansion of the deformable element (5).

2. A rod (1) according to claim 1, characterized in that the deformable element (5) can be deformed resiliently.

3. A rod (1) according to one or more of the preceding claims, characterized in that the control mechanism (6) comprises at least one lever (7) connected pivotably to a pin (8) associated with the deformable element (5).

4. A rod (1) according to one or more of the preceding claims, characterized in that the lever (7) is associated pivotably with a support (9) fixed firmly to the outer tubular element (3).

5. A rod (1) according to one or more of the preceding claims, characterized in that the lever (7) is associated slidably with a support (9) fixed firmly to the outer tubular element (3).

6. A rod (1) according to one or more of the preceding claims, characterized in that the support (9) has at least one cam (10) with which a guide portion (11) of the lever (7) is associated.

7. A rod (1) according to one or more of the preceding claims, characterized in that the guide portion (11) carries a wheel (12).

8. A rod (1) according to one or more of the preceding claims, characterized in that the cam (10) has a recessed seat (13) for housing the wheel (12).

9. A rod (1) according to one or more of the preceding claims, characterized in that the pin (8) carries the deformable element (5) and also carries, associated slidingly, a spacer (15) disposed between the lever (7) and the deformable element (5).

10. A rod (1) according to one or more of the preceding claims, characterized in that the pivotable connection of the pin (8) to the lever (7) is situated in a region (18) which is disposed at a first distance from one edge of the lever (7), which edge is associated with the spacer (15) when the rod (1) is not locked, and at a second distance from another edge of the lever (7), which edge is associated with the spacer (15) when the device is locked, the second distance being greater than the first distance.

11. A rod (1) according to one or more of the preceding claims, characterized in that centring spacers (19, 20) are disposed between the inner tubular element (2) and the outer tubular element (3).

12. A rod (1) according to one or more of the preceding claims, characterized in that the lever (7) has stop means.

13. A rod (1) according to one or more of the preceding claims, characterized in that the stop means comprise a first seat (21) of the lever (7), for housing an operating handle (22).

14. A rod (1) according to one or more of the preceding claims, characterized in that it has a resilient element (23) associated with at least one of its free ends.

15. A method of bringing about locking between two tubular elements (2, 3) of a telescopic rod (1), characterized in that a deformable element (5) is expanded transversely and is simultaneously translated longitudinally, bringing about loose locking of the deformable element (5) inside an inner tubular element (2) of the telescopic rod (1) and longitudinal translation of the inner tubular element (2) itself and, subsequently, further expansion of the deformable element (5) causing firm locking of the deformable element (5) in the inner tubular element (2).

16. A method according to claim 15, characterized in that, when the deformable element is locked loosely relative to the inner tubular element (2) of the rod (1) and the ends of the rod (1) are restrained, preventing their translation, the deformable element (5) slides in the inner tubular element (2).

17. A telescopic support rod (1) and a method of connecting two tubular elements (2, 3) of a telescopic rod, the whole as described and claimed.
